(19) United States
(12) Patent Application Publication
(10) Pub. No.: US 2025/0103114 A1
(43) Pub. Date: Mar. 27, 2025

(54) METHOD OF MANAGING POWER SUPPLY FOR SERVER SYSTEM

(71) Applicant: MITAC COMPUTING TECHNOLOGY CORPORATION, Taoyuan City (TW)

(72) Inventor: Yu-Zhe CHIANG, Taoyuan City (TW)

(21) Appl. No.: 18/890,378

(22) Filed: Sep. 19, 2024

(30) Foreign Application Priority Data
Sep. 23, 2023 (TW) 112136474

(51) Int. Cl. G06F 1/26

(52) U.S. Cl. CPC G06F 1/26

(57) ABSTRACT

A method of managing power supply for a server system includes steps of: A) selecting a to-be-processed item from among first power-on items of first power-on sequence data, and determining whether there is at least one batch-processed item among second power-on items of second power-on sequence data according to the to-be-processed item; B) when it is determined that there is at least one batch-processed item, performing a power-on procedure related to the to-be-processed item and transmitting a power-on notification to a system board; C) transmitting a result request to the system board; D) in response to receipt of a power-on result responded by the system board, determining whether at least one power-on state indicates success; and E) when it is determined that the at least one power-on state indicates success, repeating steps A) to D) until all of the first power-on items have been selected.

### CROSS-REFERENCE TO RELATED APPLICATION

This application claims priority to Taiwanese Invention Patent Application No. 112136474, filed on Sep. 23, 2023, and incorporated by reference herein in its entirety.

### FIELD

The disclosure relates to a method of managing power supply for a server system.

### BACKGROUND

A server system is configured to realize functions such as computational processes, network transmission, data storage and so on, and includes a power supply, a mainboard, and at least one system board. Each of the mainboard and the at least one system board includes at least one power controlling component (e.g., a voltage regulator, VR) and at least one switching controller. The at least one switching controller of the mainboard is controlled to send an enabling signal to the at least one power controlling component of the mainboard, so as to enable the at least one power controlling component to convert common power supplied by the power supply into various mainboard power required by chipsets and devices on the mainboard, and to supply the mainboard power to the chipsets and the devices on the mainboard. Similarly, for each of the at least one system board, the at least one switching controller on the system board is controlled to send an enabling signal to the at least one power controlling component on the system board, so as to enable the at least one power controlling component to convert common power supplied by the power supply into various system-board power required by chipsets and devices on the system board, and to supply the system-board power to the chipsets and the devices on the system board. It should be noted that since the switching controller of the mainboard and the switching controller of the at least one system board do not communicate with each other, after the switching controller of each of the mainboard and the at least one system board (hereinafter also referred to as each board) receives the common power supplied by the power supply, the way of the switching controller of the each board processing the common power thus received (i.e., the timing and the order of converting the common power into various power required by various hardware components of the each board) is independent from that of another of the mainboard and the at least one system board. Therefore, hardware components of the server system that require power of the same voltage level and that are expected to cooperate with each other may not be activated at the same time. Such phenomenon may cause malfunction of the server system during power cycling (i.e., the act of turning the server system off and then on again). For example, in a DC power cycle test of a server system that includes a system board implemented by a combo hot-plugging backboard which includes a PCIe/SAS solid-state drive (SSD), hard disk drive failure may occur several times during power cycling due to discrepancy in powering the mainboard and the system board caused by the difference between the mainboard power and the system-board power.

It is worth to note that in a scenario where the mainboard and the at least one system board are powered together while a number of voltage levels (e.g., 18V, 5V, and 3.3V) into which the mainboard is to convert the common power is different from a number of voltage levels (e.g., 18V, 12V, 5V, and 3.3V) into which the at least one system board is to convert the common power. For a consistent voltage level (e.g., 5V) into which both of the mainboard and the at least one system board are to convert the common power, a time point at which the mainboard converts the common power into the power of the consistent voltage level may be inconsistent with a time point at which the at least one system board converts the common power into the power of the consistent voltage level, even when the mainboard and the at least one system board convert the common power both in a descending order of voltage levels. For example, the mainboard may convert the common power into 5V while the at least one system board may convert the common power into 12V and has not yet started to convert the common power into power of 5V.

### SUMMARY

Therefore, an object of the disclosure is to provide a method of managing power supply for a server system that can alleviate at least one of the drawbacks of the prior art.

According to the disclosure, the server system includes a mainboard and a system board. The mainboard is electrically connected to the system board. The mainboard includes a programmable logic device that stores first power-on sequence data for the mainboard and second power-on sequence data for the system board. The first power-on sequence data contains a plurality of first power-on items that are related to supplying power to the mainboard. The second power-on sequence data contains a plurality of second power-on items that are related to supplying power to the system board. The method is to be implemented by the programmable logic device of the mainboard. The method includes steps of:
A) selecting a to-be-processed item from among the first power-on items of the first power-on sequence data, and determining whether there is at least one batch-processed item among the second power-on items according to the to-be-processed item;
B) when it is determined that there is at least one batch-processed item among the second power-on items, performing a power-on procedure that is related to the to-be-processed item and transmitting to the system board a power-on notification for the system board performing at least one power-on procedure related respectively to the at least one batch-processed item;
C) transmitting to the system board a result request for a power-on result of the at least one power-on procedure related to the at least one batch-processed item;
D) in response to receipt of the power-on result that is responded by the system board to the result request and that contains at least one power-on state corresponding respectively to the at least one batch-processed item, determining whether the at least one power-on state all indicates success in the at least one power-on procedure related to the at least one batch-processed item; and
E) when it is determined that the at least one power-on state all indicates success, repeating steps A) to D) until all of the first power-on items of the first power-on sequence data have been selected.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a server system according to an embodiment of the disclosure.

FIG. 2 is a flow chart illustrating a method of managing power supply for the server system according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

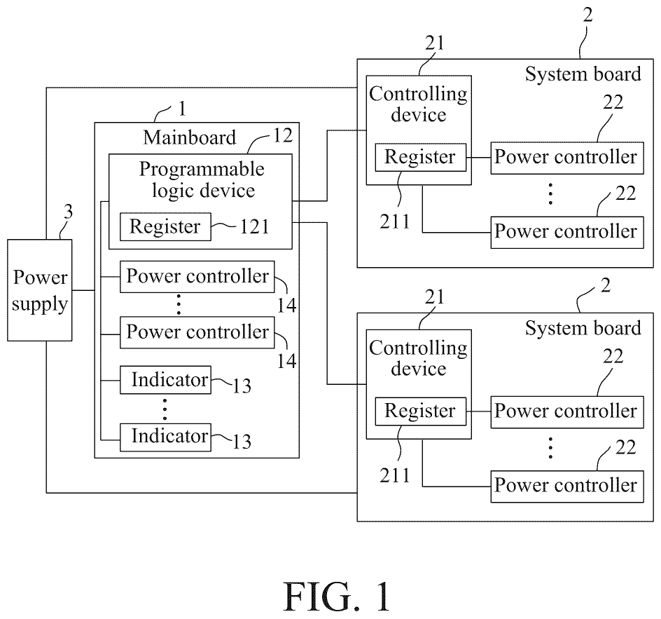

Referring to FIG. 1, an embodiment of a server system according to the disclosure is illustrated. The server system may be implemented to be a computing server or a data server, but implementation of the server system is not limited to the disclosure herein and may vary in other embodiments. The server system includes a power supply 3, a mainboard 1, and a plurality of system boards 2. The mainboard 1 is electrically connected to each of the system boards 2. The power supply 3 is electrically connected to the mainboard 1 and each of the system boards 2. The power supply 3 supplies electric power to the mainboard 1 and each of the system boards 2. For the sake of clearer explanation, only one of the system boards 2 is given as an example hereinafter. However, it should be noted that a limitation is not placed on the quantity of the system boards 2.

The mainboard 1 includes a programmable logic device 12. The programmable logic device 12 includes a register 121. The register 121 stores first power-on sequence data for the mainboard 1 and second power-on sequence data for the system board 2. The first power-on sequence data contains a plurality of first power-on items that are related to supplying power to the mainboard 1. The second power-on sequence data contains a plurality of second power-on items that are related to supplying power to the system board 2.

The mainboard 1 further includes a plurality of indicators 13 that correspond respectively to the second power-on items, and a plurality of power controllers 14 that correspond respectively to the first power-on items. The programmable logic device 12 is electrically connected to each of the indicators 13 and each of the power controllers 14. In this embodiment, each of the power controllers 14 is exemplarily implemented by a voltage regulator (VR), but is not limited thereto.

The system board 2 includes a controlling device 21 and a plurality of power controllers 22. The controlling device 21 is electrically connected to each of the power controllers 22. The controlling device 21 includes a register 211 that stores the second power-on sequence data. In this embodiment, the controlling device 21 is implemented by a complex programmable logic device (CPLD), but implementation of the controlling device 21 is not limited thereto and may vary in other embodiments. For example, the controlling device 21 may be implemented to be a general-purpose input/output (GPIO) expander that supports system management bus (SMBus) protocols, a field programmable gate array (FPGA), a micro control unit (MCU) or the like. The power controllers 22 correspond respectively to the second power-on items. In this embodiment, each of the power controllers 22 is exemplarily implemented by a VR, but is not limited thereto.

The first power-on items respectively correspond to a plurality of first power-on voltages (e.g., 5V, 3.3V, and 1.8V), and the second power-on items respectively correspond to a plurality of second power-on voltages (e.g., 5V, 4.8V, 3.3V, and 1.8V). The first power-on items are arranged in the first power-on sequence data in a descending order of the first power-on voltages, and the second power-on items are arranged in the second power-on sequence data in a descending order of the second power-on voltages. It should be noted that in this embodiment, a maximal one of the first power-on voltages is not smaller than that of the second power-on voltages. Each of the first power-on items is related to a power-on procedure that is related to powering hardware components (e.g., a processor, a memory device, a chipset, a fan and so on) of the mainboard 1. Each of the second power-on items is related to a power-on procedure that is related to powering hardware components (e.g., a processor, a memory device, a chipset, a fan and so on) of the system board 2. Each of the indicators 13 is configured to indicate whether or not success is achieved in a corresponding one of the power-on procedure related to a corresponding one of the second power-on items. It is worth to note that success in a corresponding one of the power-on procedure related to a corresponding one of the first power-on items means that relevant hardware components of the mainboard 1 have been successfully powered on by a corresponding one of the power controllers 14 for normal operation, and success in a corresponding one of the power-on procedure related to a corresponding one of the second power-on items means that relevant hardware components of the system board 2 have been successfully powered on by a corresponding one of the power controllers 22 for normal operation.

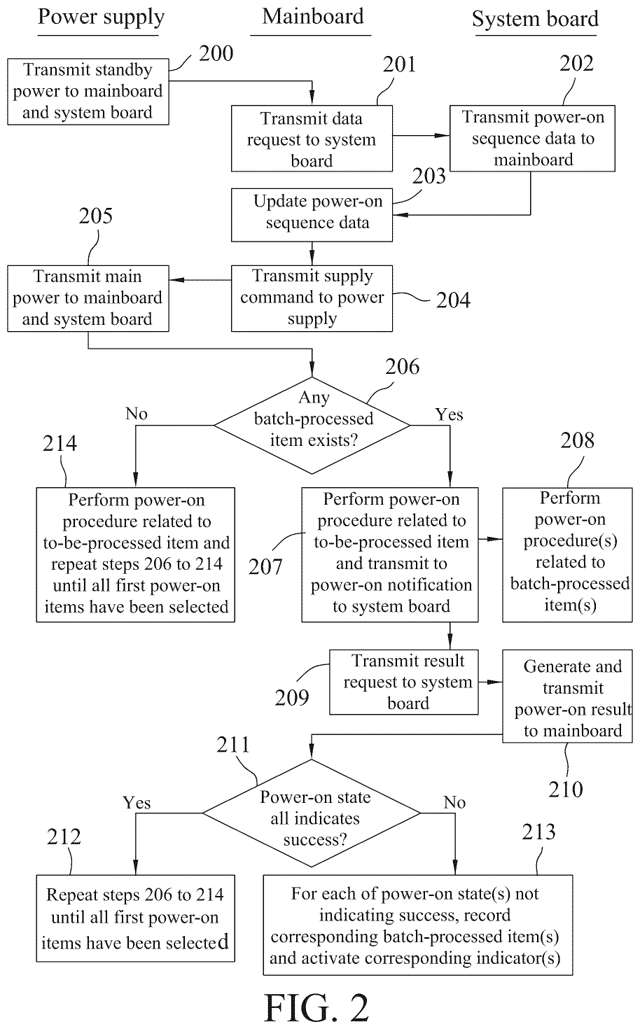

Referring to FIG. 2, an embodiment of a method of managing power supply for a server system is illustrated. The method is to be implemented by the server system that is previously described. The method includes steps 200 to 214 delineated below.

In step 200, the power supply 3 transmits standby power to the mainboard 1 and the system board 2. The standby power refers to a least amount of electric power to be consumed by each of the mainboard 1 and the system board 2 when each of the mainboard 1 and the system board 2 operates in a standby mode. It is worth to note that in this embodiment, the power supply 3 directly transmits the standby power to each of the mainboard 1 and the system board 2. However, in other embodiments, the power supply 3 directly transmits the standby power to the mainboard 1 at first, and then the mainboard 1 distributes the standby power to itself and the system board 2.

In step 201, in response to receipt of the standby power from the power supply 3, the programmable logic device 12 of the mainboard 1 is powered up for operation, and then transmits a data request to the system board 2. In particular, in this embodiment, the programmable logic device 12 transmits the data request to the system board 2 via a SMBus connecting the mainboard 1 and the system board 2. It should be note that implementation of a communication interface supported by each of the mainboard 1 and the system board 2 is not limited to the disclosure herein and may vary in other embodiments. For example, in some embodiments, the programmable logic device 12 transmits the data request to the system board 2 via one of a serial general purpose input/output (SGPIO) bus and an inter-integrated circuit (I²C) bus.

In step 202, after receiving the standby power, the controlling device 21 of the system board 2 is powered up for operation. In addition, in response to receipt of the data request from the mainboard 1, the controlling device 21 transmits the second power-on sequence data via the SMBus to the mainboard 1.

In step 203, in response to receipt of the second power-on sequence data that is responded by the system board 2 to the data request, the programmable logic device 12 of the mainboard 1 stores the second power-on sequence data in the register 121 so as to update the second power-on sequence data that has been stored therein.

In step 204, in response to receipt of a start signal (which may be generated according to user operation on the server system), the mainboard 1 transmits a supply command to the power supply 3.

In step 205, in response to receipt of the supply command, the power supply 3 transmits main power to the mainboard 1 and the system board 2 for normal operation of each of the mainboard 1 and the system board 2. It is worth to note that in this embodiment, the power supply 3 directly transmits the main power to each of the mainboard 1 and the system board 2. However, in other embodiments, the power supply 3 directly transmits the main power to the mainboard 1 at first, and then the mainboard 1 distributes the main power to itself and the system board 2.

In step 206, at the start of normal operation of the mainboard 1, the programmable logic device 12 of the mainboard 1 selects a to-be-processed item from among the first power-on items of the first power-on sequence data, and determines whether there is at least one batch-processed item among the second power-on items according to the to-be-processed item. In this embodiment, each of the at least one batch-processed item is one of the second power-on items corresponding the second power-on voltage that is not greater than the first power-on voltage corresponding to the first power-on item which is selected as the to-be-processed item, and that is greater than the first power-on voltage corresponding to a subsequent one of the first power-on items next to the to-be-processed item in the first power-on sequence data. Following the previously-described example where the first power-on items respectively correspond to the first power-on voltages 5V, 3.3V and 1.8V, and the second power-on items respectively correspond to the second power-on voltages 5V, 4.8V, 3.3V and 1.8V, when the first power-on voltage corresponding to the to-be-processed item is 5V and the first power-on voltage corresponding to a subsequent one of the first power-on items next to the to-be-processed item is 3.3V, two of the second power-on items respectively corresponding the second power-on voltages of 5V and 4.8V will be the batch-processed items. In the case where the to-be-processed item is the last one of the first power-on items in the first power-on sequence data, each of the at least one batch-processed item is one of the second power-on items corresponding to the second power-on voltage that is not greater than the first power-on voltage corresponding to the first power-on item which is selected as the to-be-processed item. For example, when the first power-on voltage corresponding to the to-be-processed item is 1.8V, one of the second power-on items corresponding the second power-on voltage 1.8V will be the batch-processed item. When it is determined that there is at least one batch-processed item among the second power-on items, a procedure flow of the method proceeds to step 207. Otherwise, when it is determined that there is no batch-processed item among the second power-on items, the procedure flow proceeds to step 214.

It should be noted that the programmable logic device 12 selects the to-be-processed item from among the first power-on items of the first power-on sequence data in a descending order of the first power-on voltages. That is to say, when step 206 is performed for the first time, the programmable logic device 12 selects a first one of the first power-on items as the to-be-processed item. When step 206 is performed not for the first time, one of the first power-on items that will be selected by the programmable logic device 12 as the to-be-processed item is next to an immediately previous one of the first power-on items that has been selected as the to-be-processed item when step 206 was immediately previously performed.

In step 207, the programmable logic device 12 of the mainboard 1 performs a power-on procedure that is related to the to-be-processed item and transmits to the system board 2 a power-on notification for the system board 2 performing at least one power-on procedure related respectively to the at least one batch-processed item. In particular, the programmable logic device 12 performs the power-on procedure by controlling one of the power controllers 14 corresponding to the to-be-processed item to operate to convert the main power into demanded power that has one of the first power-on voltages which corresponds to the to-be-processed item. The demanded power thus converted is subsequently supplied to relevant hardware components of the mainboard 1 for operation.

In step 208, in response to receipt of the power-on notification from the mainboard 1, the controlling device 21 of the system board 2 performs at least one power-on procedure related respectively to the at least one batch-processed item. In particular, for each of the at least one batch-processed item, the controlling device 21 performs a power-on procedure by controlling one of the power controllers 22 corresponding to the batch-processed item to operate to convert the main power into demanded power that has one of the second power-on voltages which corresponds to the batch-processed item. The demanded power thus converted is subsequently supplied to relevant hardware components of the system board 2 for operation.

In step 209, the programmable logic device 12 of the mainboard 1 transmits to the system board 2 a result request for a power-on result of the at least one power-on procedure related to the at least one batch-processed item.

In step 210, in response to receipt of the result request from the mainboard 1, the controlling device 21 of the system board 2 responds the result request by generating and transmitting the power-on result to the mainboard 1, wherein the power-on result contains at least one power-on state corresponding respectively to the at least one batch-processed item.

In step 211, in response to receipt of the power-on result from the system board 2, the programmable logic device 12 of the mainboard 1 determines whether the at least one power-on state all indicates success in the at least one power-on procedure related to the at least one batch-processed item. When it is determined that the at least one power-on state all indicates success, the procedure flow proceeds to step 212. On the other hand, when it is determined that not all of the at least one power-on state indicate success, the procedure flow proceeds to step 213.

In step 212, the programmable logic device 12 of the mainboard 1 repeats steps 206 to 214 until all of the first power-on items of the first power-on sequence data have been selected.

In step 213, for each of the at least one power-on state that does not indicate success, the programmable logic device 12 of the mainboard 1 records a corresponding one of the at least one batch-processed item that corresponds to the power-on state, and transmits an indicator command to a corresponding one of the indicators 13 to activate the corresponding one of the indicators 13, wherein the corresponding one of the indicators 13 corresponds to the second power-on item that is determined as one of the at least one batch-processed item which corresponds to the power-on state not indicating success. In this way, a user of the server system may be notified about which one(s) of the second power-on items that is related to failure in a power-on procedure.

In step 214, the programmable logic device 12 of the mainboard 1 performs the power-on procedure that is related to the to-be-processed item without transmitting the power-on notification to the system board 2, and repeats the steps of selecting another one of the first power-on items as another to-be-processed item, and determining whether at least another one second to-be-processed item exists, until all of the first power-on items of the entry of first power-on sequence data have been selected.

To sum up, for the method of managing power supply for a server system according to the disclosure, a power-on procedure that is related to one of the first power-on items of the first power-on sequence data for the mainboard 1 is performed together with at least one power-on procedure that is respectively related to at least one of the second power-on items of the second power-on sequence data for the system board 2, wherein at least one second power-on voltage respectively corresponding to the at least one of the second power-on items is similar to a first power-on voltage corresponding to the one of the first power-on items. In this way, malfunction of the server system caused by discrepancy in powering the mainboard 1 and the system board 2 during power cycling may be prevented.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of managing power supply for a server system, the server system including a mainboard and a system board, the mainboard being electrically connected to the system board, the mainboard including a programmable logic device that stores first power-on sequence data for the mainboard and second power-on sequence data for the system board, the first power-on sequence data containing a plurality of first power-on items that are related to supplying power to the mainboard, the second power-on sequence data containing a plurality of second power-on items that are related to supplying power to the system board, the method being to be implemented by the programmable logic device of the mainboard and comprising steps of:
A) selecting a to-be-processed item from among the first power-on items of the first power-on sequence data, and determining whether there is at least one batch-processed item among the second power-on items according to the to-be-processed item;
B) when it is determined that there is at least one batch-processed item among the second power-on items, performing a power-on procedure that is related to the to-be-processed item and transmitting to the system board a power-on notification for the system board to perform at least one power-on procedure related respectively to the at least one batch-processed item;
C) transmitting to the system board a result request for a power-on result of the at least one power-on procedure related to the at least one batch-processed item;
D) in response to receipt of the power-on result that is responded by the system board to the result request and that contains at least one power-on state corresponding respectively to the at least one batch-processed item, determining whether the at least one power-on state all indicates success in the at least one power-on procedure related to the at least one batch-processed item; and
E) when it is determined that the at least one power-on state all indicates success, repeating steps A) to D) until all of the first power-on items of the first power-on sequence data have been selected.

2. The method as claimed in claim 1, further comprising:
when it is determined that there is no batch-processed item among the second power-on items, performing the power-on procedure that is related to the to-be-processed item without transmitting the power-on notification to the system board, and repeating the steps of selecting another one of the first power-on items as another to-be-processed item, and determining whether at least another one second to-be-processed item exists, until all of the first power-on items of the entry of first power-on sequence data have been selected.

3. The method as claimed in claim 1, further comprising:
when it is determined that not all of the at least one power-on state indicate success, for each of the at least one power-on state that does not indicate success, recording a corresponding one of the at least one batch-processed item that corresponds to the power-on state.

4. The method as claimed in claim 1, the mainboard further including a plurality of indicators that correspond respectively to the second power-on items, the method further comprising:
when it is determined that not all of the at least one power-on state indicate success, for each of the at least one power-on state that does not indicate success, transmitting an indicator command to a corresponding one of the indicators to activate the corresponding one of the indicators, the corresponding one of the indicators corresponding to the second power-on item that is determined as one of the at least one batch-processed item which corresponds to the power-on state not indicating success.

5. The method as claimed in claim 1, the server system further including a power supply that is electrically connected to the mainboard and the system board and that supplies electric power to the mainboard and the system board, the method further comprising, prior to step A):
the power supply transmitting standby power to the mainboard and the system board;
in response to receipt of the standby power from the power supply, the programmable logic device of the mainboard transmitting a data request to the system board; and
in response to receipt of the second power-on sequence data that is responded by the system board to the data request, the programmable logic device of the mainboard storing the second power-on sequence data.

6. The method as claimed in claim 5, further comprising, prior to step A):
the power supply transmitting main power to the mainboard and the system board.

7. The method as claimed in claim 1, further comprising, prior to step A):
the power supply transmitting main power to the mainboard and the system board.

8. The method as claimed in claim 1, the first power-on items respectively corresponding to a plurality of first power-on voltages, the second power-on items respectively corresponding to a plurality of second power-on voltages,
wherein, in step A), each of the at least one batch-processed item is one of the second power-on items corresponding to the second power-on voltage that is not greater than the first power-on voltage corresponding to the first power-on item which is selected as the to-be-processed item.

9. The method as claimed in claim 8, the first power-on items being arranged in the first power-on sequence data in a descending order of the first power-on voltages, 10 the second power-on items being arranged in the second power-on sequence data in a descending order of the second power-on voltages,
wherein, in step A), each of the at least one batch-processed item is one of the second power-on items corresponding the second power-on voltage that is not greater than the first power-on voltage corresponding to the first power-on item which is selected as the to-be-processed item and that is greater than the first power-on voltage corresponding to a subsequent one of the first power-on items next to the to-be-processed item in the first power-on sequence data.

10. The method as claimed in claim 1, the first power-on items respectively corresponding to a plurality of first power-on voltages, the second power-on items respectively corresponding to a plurality of second power-on voltages, the first power-on items being arranged in the first power-on sequence data in a descending order of the first power-on voltages, the second power-on items being arranged in the second power-on sequence data in a descending order of the second power-on voltages,
wherein, in step A), each of the at least one batch-processed item is one of the second power-on items corresponding the second power-on voltage that is not greater than the first power-on voltage corresponding to the first power-on item which is selected as the to-be-processed item and that is greater than the first power-on voltage corresponding to a subsequent one of the first power-on items next to the to-be-processed item in the first power-on sequence data.
